(19) United States
(12) Patent Application Publication
(10) Pub. No.: US 2007/0204514 A1
(43) Pub. Date: Sep. 6, 2007

(54) Tunnel/wall unit

(75) Inventor: Andrew S. Grimmett, Athens, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/366,347

(22) Filed: Mar. 2, 2006

(51) Int. Cl. E05D 15/48

(52) U.S. Cl. 49/169

(57) ABSTRACT

An apparatus for defining a tunnel through a wall includes a first elongated tubular section having an outboard end and a distal end. A first peripheral flange extends around at least a portion of the periphery of the outboard end of the first elongated tubular section. A second elongated tubular section has an outboard end and a distal end. A second peripheral flange extends around at least a portion of the periphery of the outboard end of the second elongated tubular section. The cross-sectional shape and dimensions of the second elongated tubular section are sized to slidingly telescope within the first tubular section when the distal end of the first tubular section is inserted through a hole in a first side of a wall and the distal end of the second tubular section is inserted through a coaxial hole in the opposing side of the wall.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a pre-fabricated tunnel to allow passage through a wall, by a pet, for example.

More particularly, this invention pertains to a slidingly telescoped tunnel for insertion through opposing sides of a wall.

2. Description of the Related Art

Many efforts have been made to provide pets with access from one room to another room in a building or between the interior and exterior of a building. Most of these efforts have focused upon adding a smaller door within a larger door. In some cases, however, the building owner does not want to damage the main door, and instead cuts a hole in a wall and custom-builds a tunnel through the wall, along with a frame on each side of the wall. For a typical homeowner, the construction of a tunnel through a wall requires professional assistance.

U.S. Pat. No. 5,287,654, discloses a modular pet access door unit for insertion into a hole cut into a door or wall. The unit includes an exterior frame for each side of the wall and a plurality of spacer frames for filling the space between the two exterior frames. The spacer frames allow air flow in and out of the wall space and provide no allowance for marginally variable wall thickness. Instead, gaps may be left between the walls and the exterior frames.

The present invention provides a tunnel adaptable to walls of varying thickness and prevents drafts or insects from passing between the living space and the interior of the wall.

### BRIEF SUMMARY OF THE INVENTION

According to one embodiment of the present invention, a first elongated tubular section includes an outboard end and a distal end. A first peripheral flange extends around at least a portion of the periphery of the outboard end of the first elongated tubular section. A second elongated tubular section includes an outboard end and a distal end. A second peripheral flange extends around at least a portion of the periphery of the outboard end of the second elongated tubular section. The cross-sectional dimensions of the second tubular section are sized to slidingly telescope within the first tubular section when the distal end of the first tubular section is inserted through a hole in a first side of a wall and the distal end of the second tubular section is inserted through a coaxial hole in the opposing side of the wall.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective exploded view of one embodiment of the present invention.

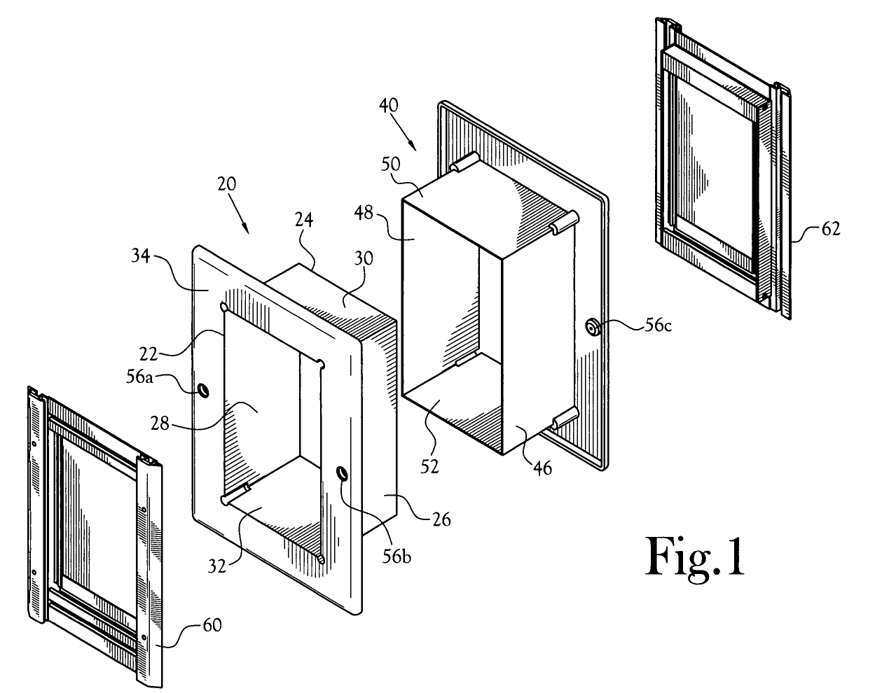

FIG. 2 is a perspective view of the embodiment of FIG. 1, assembled and mounted through a sectioned wall.

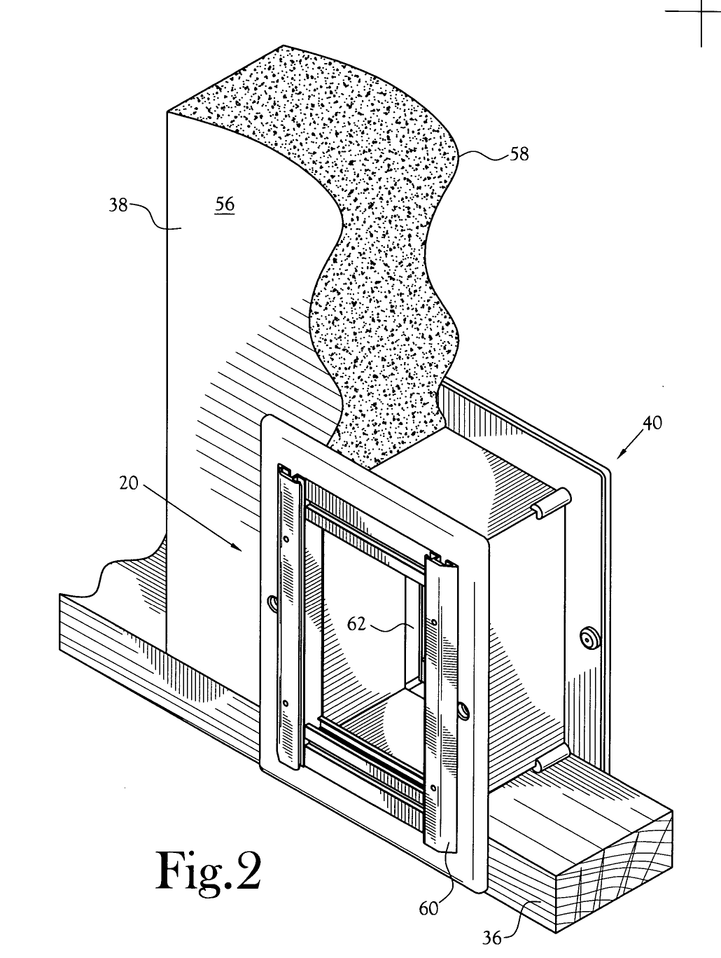

### DETAILED DESCRIPTION OF THE INVENTION

An apparatus for defining a tunnel through a wall is illustrated in the figures. A first elongated tubular section 20 includes an outboard end 22, a distal end 24. In the depicted embodiment, the first elongated tube section 20 is rectangular in cross-section. However, any cross-sectional shape may be employed with in the scope of the present invention. The dimensions of the cross-sectional shape are adapted to typical sizes of dogs and cats most likely to be using the tunnel. Additionally, the width of the first elongated tube section is preferably less than 14 inches in order to fit within typical stud spacing in a wall.

The first elongated tubular section 20 is cooperatively defined by a first side panel 26, an opposed second side panel 28, a top panel 30 and a bottom panel 32.

A first peripheral flange 34 extends around at least a portion of the periphery of the outboard end 22 of the first elongated tubular section 20. The width of the first peripheral flange 34 is adapted to cover small irregularities in the hole to be defined in the wall 28. The first peripheral flange 26 preferably has a width of about 1.5 inches to about 1.7 inches, in order to raise the first elongated tube section above a plate 36 located at the base of the wall 38.

A second elongated tubular section 40 includes an outboard end 42 and a distal end 44. The second elongated tubular section 40 is rectangular in cross-section, cooperatively defined by a first side panel 46, an opposed second side panel 48, a top panel 50 and a bottom panel 52. The cross-sectional shape and outer dimensions of the second tubular section 40 are sized to slidingly telescope within the first tubular section 20.

A second peripheral flange 54 extends around at least a portion of the periphery of the outboard end 42 of the second elongated tubular section 40. The width of the second peripheral flange 54 is adapted to cover small irregularities in the hole to be defined in the wall 38. The second peripheral flange 54 preferably has a width of about 1.5 inches to about 1.7 inches, in order to raise the second elongated tube section 40 above the plate 36 located at the base of the wall 38.

Apertures 56a and 56b are defined in the first peripheral flange 34 to permit secure attachment of the first peripheral flange 34 to the wall 38. Apertures 56c and 56d (not shown) are defined in the second peripheral flange 54 to permit secure attachment of the second peripheral flange 54 to the wall 38.

The first elongated tubular section 20 and the second elongated tubular section 40 are preferably molded from a plastic material, using a reverse draft molding process.

In operation, a hole is defined in the wall 38, extending through both opposing sides 56 and 58 of the wall 38. The shape and dimensions of the hole are adapted to allow insertion of the distal end 24 of the first tubular section 20 into the hole. When the distal end 24 of the first tubular section 20 is fully inserted through a hole in a first side 56 of a wall 38, the first peripheral flange 34 engages and seals against the first side 56 of the wall 38. Screws or other attaching means are used to secure the first peripheral flange 34 to the wall 38. Caulking may be used to additionally seal the first peripheral flange 34 to the wall 38.

The distal end 44 of the second elongated tubular section 40 is inserted through the opposing second side 58 of the wall 38 to slidingly telescope within the first tubular section 20. When the distal end 44 of the second elongated tubular section 40 is fully inserted through a hole in a second side 58 of a wall 38, the second peripheral flange 54 engages and seals against the second side 58 of the wall 38. Screws or other attaching means are used to secure the second peripheral flange 54 to the wall 38. Caulking may be used to additionally seal the first peripheral flange 34 to the wall 38. Caulking may also be applied around the periphery of the distal end 44 of the second elongated tubular section 40 to seal it to the interior surface of the first elongated tubular section 20.

In order to control air flow through the tunnel defined by the first elongated tubular section 20 and the second elongated tubular section 40, a first pet door 60 is mounted over the first peripheral flange 34. A second pet door 62 is mounted over the second peripheral flange 54.

Those skilled in the art will recognize that various sizes and cross-sectional shapes may be used elongated tubular sections without departing from the spirit and scope of the present invention.

From the foregoing description, it will be recognized by those skilled in the art that an improved tunnel/wall unit has been provided to allow residents to create pet passageways through walls, particularly exterior walls.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A pet tunnel comprising:
a first elongated tubular section having a distal end, an outboard end and a first peripheral flange extending around at least a portion of the periphery of said outboard end of said first elongated tubular section;
a second elongated tubular section having a distal end, an outboard end and a second peripheral flange extending around at least a portion of the periphery of said outboard end of said second elongated tubular section;
said second elongated tubular section having a cross-sectional shape and dimensions adapted to telescope within said first elongated tubular section; and
a first pet door secured to said first peripheral flange.

2. The pet tunnel of claim 1 wherein said first peripheral flange extends around the entire periphery of the outboard end of said first elongated tubular section.

3. The pet tunnel of claim 1 wherein said second peripheral flange extends around the entire periphery of the outboard end of said second elongated tubular section.

4. The pet tunnel of claim 1 wherein apertures are defined in said first peripheral flange and said second peripheral flange for securement to a wall.

5. (canceled)

6. The pet tunnel of claim 1 and further comprising a second pet door secured to said second peripheral flange.

7. The pet tunnel of claim 1 and further comprising caulking around the periphery of said distal end of said second elongated tubular section.

8. The pet tunnel of claim 1 wherein said second elongated tubular section slidingly telescopes within said first elongated tubular section.
